(19) United States
(12) Patent Application Publication
(10) Pub. No.: US 2022/0124854 A1
(43) Pub. Date: Apr. 21, 2022

(54) METHOD AND APPARATUS FOR ADAPTATION LAYER CONFIGURATION FOR USER EQUIPMENT (UE)-TO-NETWORK RELAYING IN A WIRELESS COMMUNICATION SYSTEM

(71) Applicant: ASUSTek Computer Inc., Taipei City (TW)

(72) Inventors: Li-Te Pan, Taipei City (TW); Richard Lee-Chee Kuo, Taipei City (TW)

(21) Appl. No.: 17/486,315

(22) Filed: Sep. 27, 2021

Related U.S. Application Data
(60) Provisional application No. 63/094,707, filed on Oct. 21, 2020.

(51) Int. Cl. H04W 76/15; H04W 28/02; H04W 72/12; H04W 28/06

(52) U.S. Cl. CPC H04W 76/15; H04W 28/0268; H04W 28/06; H04W 72/1284; H04W 28/0252

(57) ABSTRACT

A method and device are disclosed for adaptation layer configuration, wherein an adaptation layer is above a Uu Radio Link Control (RLC) layer and below a Uu Packet Data Convergence Protocol (PDCP) layer. In one embodiment, the method includes a network node transmitting a first Radio Resource Control (RRC) message including an adaptation layer configuration or an information for a Uu logical channel to a relay User Equipment (UE), wherein a field in the adaptation layer configuration indicates whether or not an adaptation layer header is present for the Uu logical channel and a value of the field cannot be changed after the Uu logical channel is established, and wherein the information indicates whether or not an adaptation layer is established for the Uu logical channel and the information cannot be changed after the Uu logical channel is established.

### CROSS-REFERENCE TO RELATED APPLICATIONS

The present application claims the benefit of U.S. Provisional Patent Application Ser. No. 63/094,707 filed on Oct. 21, 2020, the entire disclosure of which is incorporated herein in its entirety by reference.

### FIELD

This disclosure generally relates to wireless communication networks, and more particularly, to a method and apparatus for adaptation layer configuration for UE-to-network relaying in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

A method and device are disclosed for adaptation layer configuration, wherein an adaptation layer is above a Uu Radio Link Control (RLC) layer and below a Uu Packet Data Convergence Protocol (PDCP) layer. In one embodiment, the method includes a network node transmitting a first Radio Resource Control (RRC) message including an adaptation layer configuration or an information for a Uu logical channel to a relay User Equipment (UE), wherein a field in the adaptation layer configuration indicates whether or not an adaptation layer header is present for the Uu logical channel and a value of the field cannot be changed after the Uu logical channel is established, and wherein the information indicates whether or not an adaptation layer is established for the Uu logical channel and the information cannot be changed after the Uu logical channel is established.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a reproduction of FIG. 5.3.1-1 of 3GPP TR 23.752 V0.5.0.

FIG. 6 is a reproduction of FIG. 5.3.1-2 of 3GPP TR 23.752 V0.5.0.

FIG. 7 is a reproduction of FIG. 5.3.1-3 of 3GPP TR 23.752 V0.5.0.

FIG. 8 is a reproduction of FIG. 6.25.2-1 of 3GPP TR 23.752 V0.5.0.

FIG. 9 is a reproduction of FIG. 6.25.3-1 of 3GPP TR 23.752 V0.5.0.

FIG. 10 is a reproduction of FIG. 6.44.2-1 of 3GPP TR 23.752 V0.5.0.

FIG. 11 is a reproduction of FIG. 5.3.3.1-1 of 3GPP TS 38.331 V16.1.0.

FIG. 12 is a reproduction of FIG. 5.3.5.1-1 of 3GPP TS 38.331 V16.1.0.

FIG. 13 is a flow chart according to one exemplary embodiment.

FIG. 14 is a flow chart according to one exemplary embodiment.

FIG. 15 is a flow chart according to one exemplary embodiment.

FIG. 16 is a flow chart according to one exemplary embodiment.

FIG. 17 is a flow chart according to one exemplary embodiment.

FIG. 18 is a flow chart according to one exemplary embodiment.

FIG. 19 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: TR 23.752 V0.5.0, “Study on system enhancement for Proximity based services (ProSe) in the 5G System (5GS) (Release 17)”; TS 38.331 V16.1.0, “NR; Radio Resource Control (RRC) protocol specification (Release 16)”; and R2-2008047, “Study aspects of UE-to-Network relay and solutions for L2 relay”, Huawei, HiSilicon. The standards and documents listed above are hereby expressly incorporated by reference in their entirety.

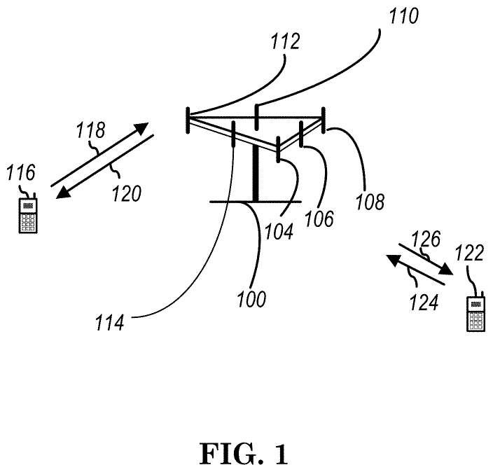

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), a network node, a network, or some other terminology. An access terminal (AT) may also be called user equipment (UE), a wireless communication device, terminal, access terminal or some other terminology.

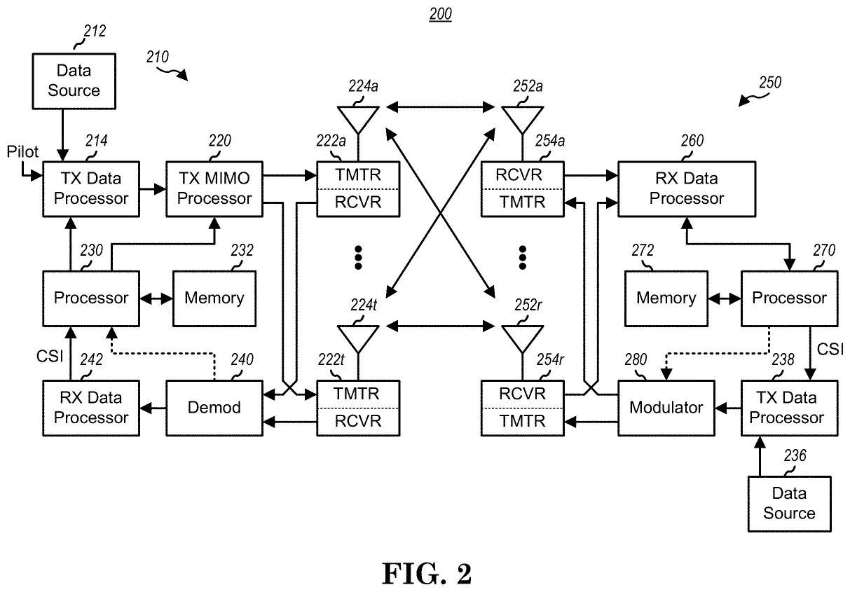

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

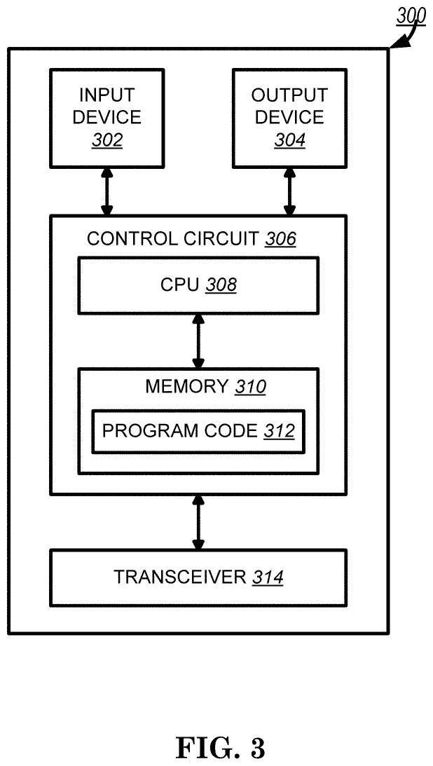

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1 or the base station (or AN) 100 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

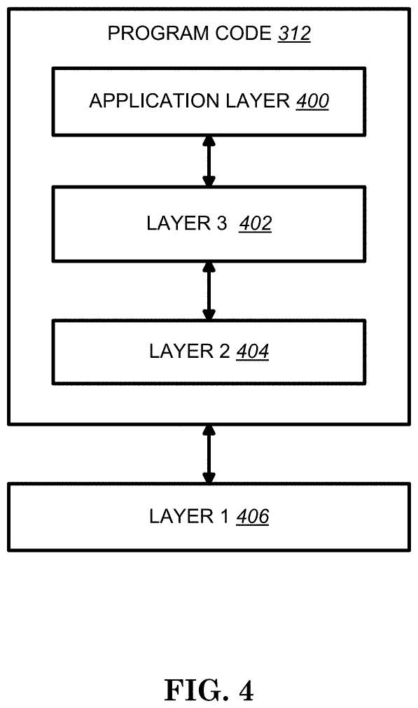

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

3GPP TR 23.752 proposes to support UE-to-Network Relay and related solutions for the following release (i.e. Release 17) as follows:

5.3 Key Issue #3: Support of UE-to-Network Relay

5.3.1 General Description

According to TS 22.261 [3] and TS 22.278 [2], support for UE-to-Network Relay needs to be studied. In addition, the Rel-16 5G architectural design (e.g. flow-based QoS communication over PC5/Uu interface) shall be taken into consideration as well.

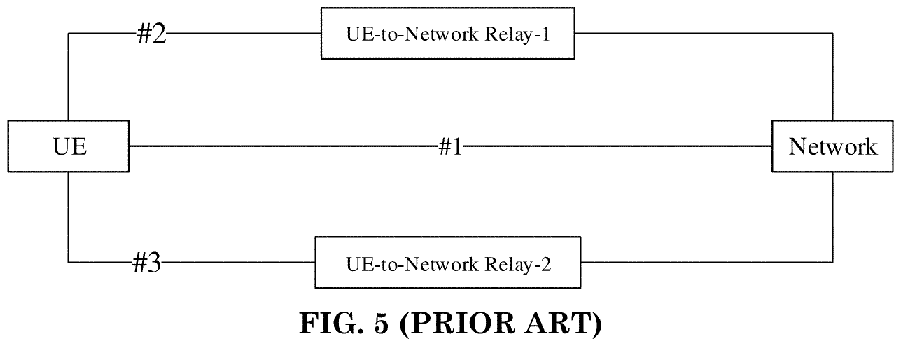

The case that UE may be able to access to network via the direct network communication or the indirect network communication illustrated in FIG. 5.3.1-1 needs to be considered, where path #1 is direct network communication path that may not exist, as well as path #2 and path #3 are indirect network communication paths via different UE-to-Network Relays.

[FIG. 5.3.1-1 of 3GPP TR 23.752 V0.5.0, Entitled “Example Scenario of Direct or Indirect Network Communication Path Between UE and Network”, is Reproduced as FIG. 5]

Therefore, 5G ProSe needs to support UE-to-Network Relay. In particular, the following aspects need to be studied:
How to authorize a UE to be a 5G UE-to-Network Relay and how to authorize a UE to access 5GC via a 5G UE-to-Network Relay.
How to establish a connection between Remote UE and a UE-to-Network Relay to support connectivity to the network for the Remote UE.
How to support end-to-end requirements between Remote UE and the network via a UE-to-Network Relay, including QoS (such as data rate, reliability, latency) and the handling of PDU Session related attributes (e.g. S-NSSAI, DNN, PDU Session Type and SSC mode).
How the network allows and controls the QoS requirement for 5G ProSe UE-to-NW relay.
How to transfer data between the Remote UE and the network over the UE-to-Network

Relay.
NOTE 1: Security and privacy aspects will be handled by SA WG3.
How to (re)select a UE-to-Network Relay for communication path selection between two indirect network communication paths (i.e. path #2 and path #3 in FIG. 5.3.1-1).
How to perform communication path selection between a direct network communication path (i.e. path #1 in FIG. 5.3.1-1) and an indirect network communication path (i.e. path #2 or path #3 in FIG. 5.3.1-1).
How to guarantee service continuity during these communication path switch procedures for switching between a direct network communication path and an indirect communication path, as well as for switching between two indirect network communication paths.
NOTE 2: Support of non-unicast mode communication (i.e. one-to-many communication/broadcast or multicast) between network and UE-to-Network Relay UE and between UE-to-Network Relay and Remote UE(s) depends on the result of FS_5MBS work.

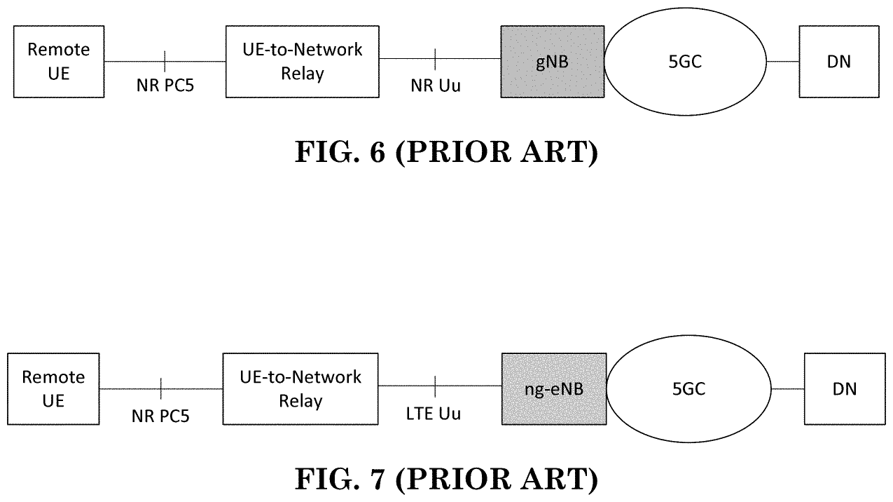

Two cases can be considered regarding support of UE-to-Network Relay, i.e. UE-to-Network Relay served by gNB as shown in FIG. 5.3.1-2 and UE-to-Network Relay served by ng-eNB as shown in FIG. 5.3.1-3.

[FIG. 5.3.1-2 of 3GPP TR 23.752 V0.5.0, Entitled “UE-to-Network Relay Served by gNB”, is Reproduced as FIG. 6]

[FIG. 5.3.1-3 of 3GPP TR 23.752 V0.5.0, Entitled “UE-to-Network Relay Served by Ng-eNB”, is Reproduced as FIG. 7]
NOTE 3: Whether to support the case that a UE-to-Network Relay is served by ng-eNB depends on solution to be identified in this study and RAN decision.
NOTE 4: When UE-to-Network Relay moves to E-UTRAN, LTE PC5 based ProSe UE-to-Network Relay can be supported as defined TS 23.303 [9] for Public Safety.
[ . . . ]

6.25 Solution #25: QoS Handling for Layer-3 UE-to-Network Relay

6.25.1 Description

This is a solution for Key Issue #3, UE-to-Network Relay. especially it's used for the QoS control of Layer-3 UE-to-Network Relay.

For a Remote UE accessing network via UE-to-Network Relay, the QoS control between Remote UE and UPF includes two parts: one part is the QoS control for the connection between remote UE and UE-to-Network Relay, the other part is the QoS control for the connection between UE-to-Network Relay and UPF. In this solution PCF is responsible to set the QoS parameters between UE and UE-to-Network Relay, (we call it “PC5 QoS parameters”), and the QoS parameters between UE-to-Network Relay and UPF (we call it “Uu QoS parameters”) separately to support the QoS requirement between Remote UE and UPF.

For PC5 interface, when standardized PQI is used, the PC5 QoS parameters includes PQI and other optional QoS parameters, e.g. GFBR. When non-standardized PQI is used, the whole set of PC5 QoS characteristics is also included.

PCF ensures the PDB associated with the 5QI in the Uu QoS parameters and the PDB associated with the PQI in the PC5 QoS parameters supports the PDB between Remote UE and UPF. PCF also ensures other QoS parameters/QoS characteristics in the Uu QoS parameters and PC5 QoS parameters are compatible, e.g. have the same value.

The UE-to-Network Relay and Remote UE are pre-configured with authorized service(s) and the related PC5 QoS parameters. These can be provided by PCF during provisioning procedure. PCF may also provide default PC5 QoS parameters to NW Relay and Remote UE, this can be used for the out of coverage Remote UE or for the applications which is not frequently used.

When a Remote UE want to use the service offered by an AF through 3GPP network, it selects a UE-to-Network Relay and establishes a PC5 connection between Remote UE and NW Relay, if the Remote UE doesn't have the PC5 QoS parameters of the service, a default PC5 QoS Flow is setup using the default PC5 QoS parameters in the provisioning information.

UE-to-Network Relay also setup a corresponding PDU session for relaying, e.g. based on the S-NSSAI, DNN requested by remote UE. After the IP address/prefix allocation, UE-to-Network Relay reports the IP info of remote UE to SMF, PCF also receives the IP info of remote UE from SMF.

If the Remote UE doesn't have the PC5 QoS parameters of the service, After the PC5 connection and the related PDU session setup, remote UE interacts with AF for the application layer controlling messages required by the service, the interaction is transferred through the default PC5 QoS Flow and the default QoS Flow of the PDU session. Then AF provides the service requirement to PCF. As PCF has received the remote UE report from SMF, PCF knows the target UE requested by AF is a remote UE, PCF generates PCC rules (for QoS control on Uu) and the PC5 QoS parameters (for QoS control on PC5), the PCF decision for example could base on the received service requirements from AF and the operator policies and the charging rate of Uu and PC5.

Alternatively, the Remote UE can send the E2E QoS requirement to PCF via relay UE over the PC5 message and NAS message without AF involved, and then the PCF performs the E2E QoS split and generates PCC rules and PC5 QoS parameters based on the remote UE provided E2E QoS requirement.

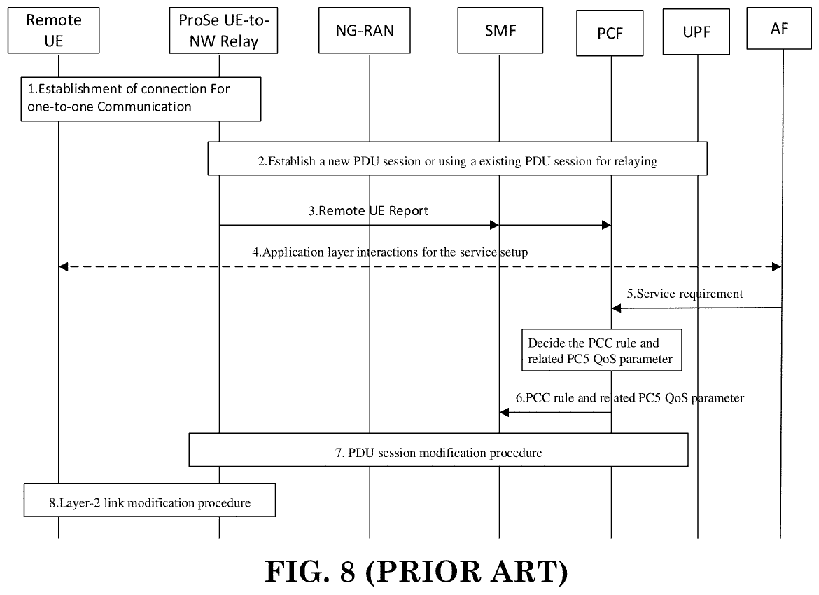

6.25.2 Procedures with AF Involved

[FIG. 6.25.2-1 of 3GPP TR 23.752 V0.5.0, Entitled “QoS Control for L3 UE-to-Network Relay with AF Involved”, is Reproduced as FIG. 8]
1. When a Remote UE want to use the service offered by an AF through 3GPP network, it selects a UE-to-Network Relay and establishes a PC5 connection between Remote UE and NW Relay, it's same as the PC5 part of step3 described in clause 6.6.2. In this step, if the Remote UE doesn't have the PC5 QoS parameters of the service, a default PC5 QoS Flow is setup using the default PC5 QoS parameters in the provisioning information.
2. UE-to-Network Relay sets up a corresponding PDU session or uses an existing PDU session for relaying, e.g. based on the S-NSSAI, DNN requested by remote UE.
3. After the IP address/prefix allocation, UE-to-Network Relay reports the IP info of remote UE to SMF, SMF also forwards the received report to PCF.
4. If the Remote UE doesn't have the PC5 QoS parameters of the service, Remote UE interacts with AF for the application layer controlling messages required by the service, the interaction is transferred through the default PC5 QoS Flow and the default QoS Flow of the PDU session.
5. Since the address used by Remote UE belongs to the UE-to-Network Relay's PDU session, AF is able to locate the UE-to-Network Relay's PCF and provides the service requirement to PCF.
6. PCF knows the target UE requested by AF is a remote UE, e.g. by the IP info provided by AF and the IP info of remote UE received from SMF. PCF generates PCC rules (for QoS control on Uu) and the PC5 QoS parameters (for QoS control on PC5), the PCF decision for example could base on the received service requirements from AF and the operator policies and the charging rate of Uu and PC5. PCF provides PCC decision to SMF.
7. Based on the PCC rules received from PCF, SMF may decides to setup a new QoS Flow or modify an existing QoS Flow for the PDU session. SMF generates QoS rule to be enforced at UE-to-Network Relay and the QoS profile to be enforced at RAN for the QoS control of Uu part. PDU session modification procedure is performed. The PC5 QoS parameters is also provided to UE-to-Network Relay together with the related QoS rule.
8. UE-to-Network Relay uses the PC5 QoS parameters received from CN to initiate the Layer-2 link modification procedure as described in TS 23.287 [5].
NOTE: In case of network scheduled operation mode for NR PC5 is used, procedures defined in TS 23.287 [5] clause 5.4.1.4 is used to authorize the PC5 QoS requests related to the relay operation.
Editor's note: How to determine PC5 QoS parameters and QoS parameters for PDU Session is FFS, such as which UE's subscription is used.

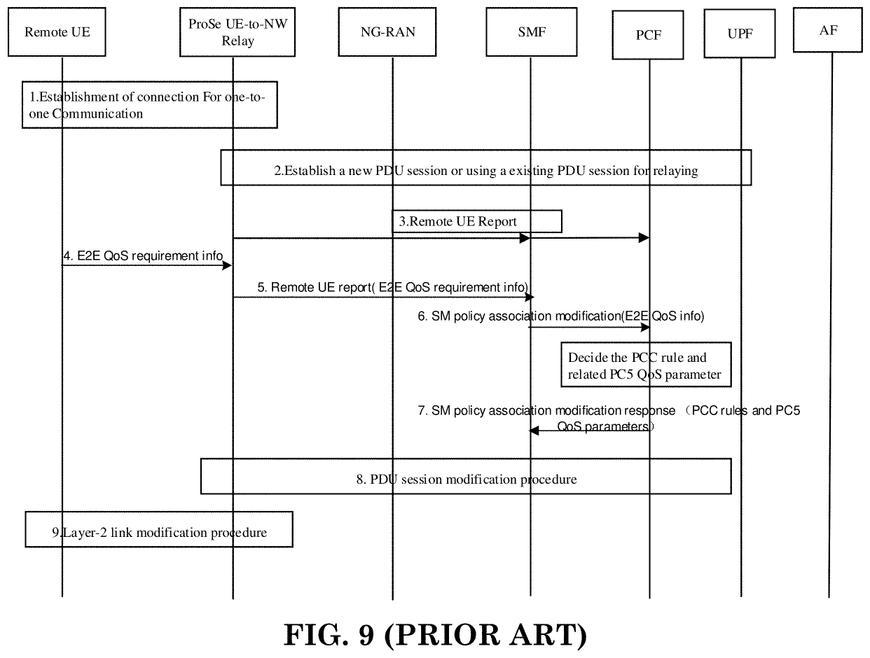

6.25.3 Procedures without AF Involved

[FIG. 6.25.3-1 of 3GPP TR 23.752 V0.5.0, Entitled “QoS Control for L3 UE-to-Network Relay without AF Involved”, is Reproduced as FIG. 9]
1˜3. Step1˜3 are same to the step1˜3 of clause 6.25.2.
4. Remote UE sends the E2E QoS requirement info to UE-to-Network relay. The E2E QoS requirement info may be the application requirement (e.g. priority requirement, reliability requirement, delay requirement) or E2E QoS parameters. The E2E QoS parameters may be derived from the application requirement or based on the mapping of the ProSe service type to E2E QoS parameters.
NOTE: It is expected that the Authorization and Provisioning for ProSe communication contains the mapping of the ProSe service type to E2E QoS parameters similar to V2X communication.
5. UE-to-Network relay forwards the E2E QoS requirement info to the SMF via the Remote UE report with the Remote UE info.
6. SMF also forwards the E2E QoS requirement info to the SMF by the SM policy association modification procedure.
7. The PCF decides the PCC rules and PC5 QoS parameters based on E2E QoS requirement info, operator policies and the charging rate of Uu and PC5. PCF provides the PCC rules and PC5 QoS parameters to the SMF.
8-9. The handling of step 8-9 is same as the step 7-8 of clause 6.25.2.

6.25.4 Impacts on Services, Entities and Interfaces

PCF:
PCF generates PCC rules (for QoS control on Uu) and the PC5 QoS parameters (for QoS control on PC5).

SMF:
Provides the PC5 QoS parameters to UE-to-Network Relay during PDU session modification procedure.

UE-to-Network Relay:
UE-to-Network Relay modify the Layer-2 link based on the PC5 QoS parameters received from CN.
Forwards the E2E QoS requirement received from remote UE to CN.

Remote UE:
Sends the E2E QoS requirement to UE-to-Network Relay.

[ . . . ]

6.44 Solution #44: QoS Handling for Layer-2 Relay

6.44.1 Description

This is a solution for Key Issue #3 “Support of UE-to-Network Relay”, which is applied to Layer-2 UE-to-Network Relay QoS handling.

In Layer 2 UE-to-NW relay solution (Solution #7), the Remote UE's data flow is served by its own PDU Session. RAN has the knowledge of that the PDU session is for Layer 2 UE-to-NW relay. In order to fulfil the QoS parameters, RAN needs to determine the suitable configurations over the PC5 leg and Uu leg. To reduce the RAN impacts, SMF can provide some guidance to RAN. SMF generates the Uu QoS profile and PC5 QoS profile and then provide them to RAN. RAN will take these QoS profiles as the principles to determine the configurations over PC5 leg and Uu leg. If the dynamic PCC control is supported, SMF can base on the PCF provided PCC rules over Uu leg and PC5 leg to generate the Uu QoS profile and PC5 QoS profile.

In this solution, it is assumed that the remote UE's core network has the knowledge of remote UE is accessing via a UE-to-Network Relay.
NOTE: The details of how to determine the configurations over Uu and PC5 legs are implemented by RAN.

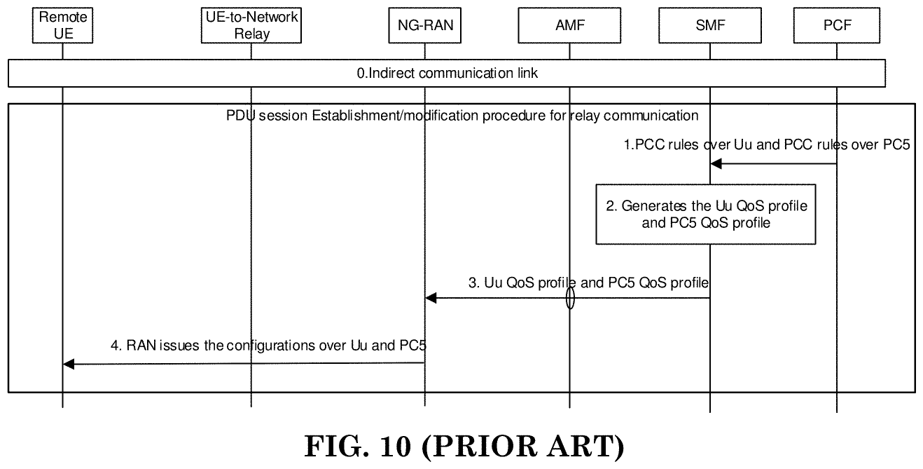

6.44.2 Procedures

[FIG. 6.44.2-1 of 3GPP TR 23.752 V0.5.0, Entitled “QoS Handling for Layer-2 Relay”, is Reproduced as FIG. 10]
0. It is assumed there is an indirect communication link for remote UE via a UE-to-Network relay based on the Layer-2 relay.
1. During the PDU session establishment or modification procedure, if the dynamic PCC control is supported, the PCF generates the PCC rules over Uu leg and PC5 leg based on the operator policies and the charging rate over Uu and PC5, and then send them to SMF in the SM Policy Association Establishment or SM Policy Association Modification procedure.
2. SMF based on the received PCC rules over Uu leg and PC5 leg generates the corresponding Uu QoS profile and PC5 QoS profile.
3. SMF sends the corresponding Uu QoS profile and PC5 QoS profile to RAN.
4. The RAN issues the configurations over Uu leg and PC5 leg based on the Uu QoS profile and PC5 QoS profile provided by SMF.

6.44.3 Impacts on Services, Entities and Interfaces PCF:
Generates PCC rules over Uu and PC5 (for QoS control over Uu and PC5).

SMF:
Generates QoS profile over Uu and PC5 (for QoS control over Uu and PC5).

RAN:
Performs the configurations over Uu and PC5 based on the SMF provided QoS profile.

3GPP TS 38.331 specifies signalling radio bearers, Radio Resource Control (RRC) connection establishment, RRC reconfiguration, and default Signaling Radio Bearer (SRB) configurations as follows:

4.2.2 Signalling Radio Bearers

“Signalling Radio Bearers” (SRBs) are defined as Radio Bearers (RBs) that are used only for the transmission of RRC and NAS messages. More specifically, the following SRBs are defined:
SRB0 is for RRC messages using the CCCH logical channel;
SRB1 is for RRC messages (which may include a piggybacked NAS message) as well as for NAS messages prior to the establishment of SRB2, all using DCCH logical channel;
SRB2 is for NAS messages and for RRC messages which include logged measurement information, all using DCCH logical channel. SRB2 has a lower priority than SRB1 and may be configured by the network after AS security activation;
SRB3 is for specific RRC messages when UE is in (NG)EN-DC or NR-DC, all using DCCH logical channel.

In downlink, piggybacking of NAS messages is used only for one dependent (i.e. with joint success/failure) procedure: bearer establishment/modification/release. In uplink piggybacking of NAS message is used only for transferring the initial NAS message during connection setup and connection resume.
NOTE 1: The NAS messages transferred via SRB2 are also contained in RRC messages, which however do not include any RRC protocol control information.

Once AS security is activated, all RRC messages on SRB1, SRB2 and SRB3, including those containing NAS messages, are integrity protected and ciphered by PDCP. NAS independently applies integrity protection and ciphering to the NAS messages, see TS 24.501 [23].

Split SRB is supported for all the MR-DC options in both SRB1 and SRB2 (split SRB is not supported for SRB0 and SRB3).

For operation with shared spectrum channel access, SRB0, SRB1 and SRB3 are assigned with the highest priority Channel Access Priority Class (CAPC), (i.e. CAPC=1) while CAPC for SRB2 is configurable.

[ . . . ]

5.3.3 RRC Connection Establishment

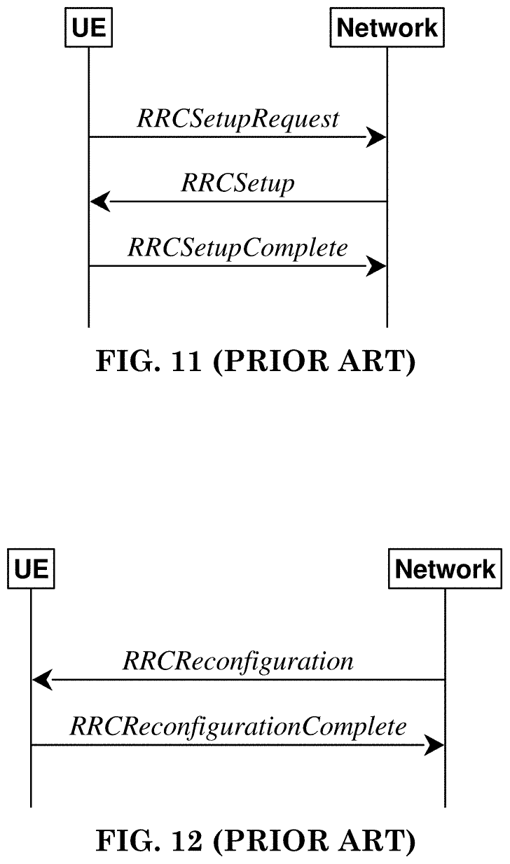

5.3.3.1 General

[FIG. 5.3.3.1-1 of 3GPP TS 38.331 V16.1.0, Entitled “RRC Connection Establishment, Successful”, is Reproduced as FIG. 11]

[ . . . ]

The purpose of this procedure is to establish an RRC connection. RRC connection establishment involves SRB1 establishment. The procedure is also used to transfer the initial NAS dedicated information/message from the UE to the network.

The network applies the procedure e.g.as follows:
When establishing an RRC connection;
When UE is resuming or re-establishing an RRC connection, and the network is not able to retrieve or verify the UE context. In this case, UE receives RRCSetup and responds with RRCSetupComplete.

[ . . . ]

5.3.5 RRC Reconfiguration

5.3.5.1 General

[FIG. 5.3.5.1-1 of 3GPP TS 38.331 V16.1.0, Entitled “RRC Reconfiguration, Successful”, is Reproduced as FIG. 12]

[ . . . ]

The purpose of this procedure is to modify an RRC connection, e.g. to establish/modify/release RBs, to perform reconfiguration with sync, to setup/modify/release measurements, to add/modify/release SCells and cell groups, to add/modify/release conditional handover configuration, to add/modify/release conditional PSCell change configuration. As part of the procedure, NAS dedicated information may be transferred from the Network to the UE.

[ . . . ]

5.3.5.2 Initiation

The Network may initiate the RRC reconfiguration procedure to a UE in RRC_CONNECTED. The Network applies the procedure as follows:
the establishment of RBs (other than SRB1, that is established during RRC connection establishment) is performed only when AS security has been activated;
the addition of Secondary Cell Group and SCells is performed only when AS security has been activated;
the reconfigurationWithSync is included in secondaryCellGroup only when at least one RLC bearer is setup in SCG;
the reconfigurationWithSync is included in masterCellGroup only when AS security has been activated, and SRB2 with at least one DRB or, for IAB, SRB2, are setup and not suspended;
the conditionalReconfiguration for CPC is included only when at least one RLC bearer is setup in SCG;
the conditionalReconfiguration for CHO is included only when AS security has been activated, and SRB2 with at least one DRB or, for IAB, SRB2, are setup and not suspended.

[ . . . ]
RRCSetup

The RRCSetup message is used to establish SRB1.
Signalling radio bearer: SRB0
RLC-SAP: TM
Logical channel: CCCH
Direction: Network to UE
RRCSetup message

-- ASN1START
-- TAG-RRCSETUP-START

| | |
|---|---|
| RRCSetup ::= | SEQUENCE { |
| rrc-TransactionIdentifier | RRC-TransactionIdentifier, |
| criticalExtensions | CHOICE { |
| rrcSetup | RRCSetup-IEs, |
| criticalExtensionsFuture | SEQUENCE { } |

}
}

| | |
|---|---|
| RRCSetup-IEs ::= | SEQUENCE { |
| radioBearerConfig | RadioBearerConfig, |
| masterCellGroup | OCTET STRING (CONTAINING |
| | CellGroupConfig), |
| lateNonCriticalExtension | OCTET STRING |

OPTIONAL,

| | |
|---|---|
| nonCriticalExtension | SEQUENCE{ } |

OPTIONAL
}
-- TAG-RRCSETUP-STOP
-- ASN1STOP

RRCSetup-IEs field descriptions

masterCellGroup
The network configures only the RLC bearer for
the SRB1, mac-CellGroupConfig,
physicalCellGroupConfig and spCellConfig.
radioBearerConfig
Only SRB1 can be configured in RRC setup.

RRCSetupComplete

The RRCSetupComplete message is used to confirm the successful completion of an RRC connection establishment.
Signalling radio bearer: SRB1
RLC-SAP: AM
Logical channel: DCCH
Direction: UE to Network
RRCSetupComplete message

-- ASN1START
-- TAG-RRCSETUPCOMPLETE-START

| | |
|---|---|
| RRCSetupComplete ::= | SEQUENCE { |
| rrc-TransactionIdentifier | RRC-TransactionIdentifier, |
| criticalExtensions | CHOICE { |
| rrcSetupComplete | RRCSetupComplete-IEs, |
| criticalExtensionsFuture | SEQUENCE { } |

}
}

| RRCSetupComplete-IEs ::= | SEQUENCE { | |
|---|---|---|
| selectedPLMN-Identity | INTEGER (1..maxPLMN), | |
| registeredAMF | RegisteredAMF | OPTIONAL, |
| guami-Type | ENUMERATED {native, mapped} | OPTIONAL, |

| | |
|---|---|
| s-NSSAI-List | SEQUENCE (SIZE (1..maxNrofS-NSSAI)) OF S-NSSAI |

OPTIONAL,

| dedicatedNAS-Message | DedicatedNAS-Message, | |
|---|---|---|
| ng-5G-S-TMSI-Value | CHOICE { | |
| ng-5G-S-TMSI | NG-5G-S-TMSI, | |
| ng-5G-S-TMSI-Part2 | BIT STRING (SIZE (9)) | |
| } | OPTIONAL, | |
| lateNonCriticalExtension | OCTET STRING | OPTIONAL, |
| nonCriticalExtension | RRCSetupComplete-v1610-IEs | OPTIONAL |

}

| RRCSetupComplete-v1610-IEs ::= | SEQUENCE { | |
|---|---|---|
| iab-NodeIndication-r16 | ENUMERATED {true} | OPTIONAL, |
| idleMeasAvailable-r16 | ENUMERATED {true} | OPTIONAL, |
| ueMeasurementsAvailable-r16 | UEMeasurementsAvailable-r16 | OPTIONAL, |
| mobilityHistoryAvail-r16 | ENUMERATED {true} | OPTIONAL, |

| | |
|---|---|
| mobilityState-r16 | ENUMERATED {normal, medium, high, spare} |

OPTIONAL,

| | | |
|---|---|---|
| nonCriticalExtension | SEQUENCE{ } | OPTIONAL |

}

| RegisteredAMF ::= | SEQUENCE { | |
|---|---|---|
| plmn-Identity | PLMN-Identity | OPTIONAL, |

| | |
|---|---|
| amf-Identifier | AMF-Identifier |

}
-- TAG-RRCSETUPCOMPLETE-STOP
-- ASN1STOP

RRCSetupComplete-IEs field descriptions

guami-Type
This field is used to indicate whether the GUAMI included is native (derived from native 5G-
GUTI) or mapped (from EPS, derived from EPS GUTI) as specified in TS 24.501 [23].
iab-NodeIndication-
This field is used to indicate that the connection is being established by an IAB-node [2].
idleMeasAvailable
Indication that the UE has idle/inactive measurement report available.
mobilityState
This field indicates the UE mobility state (as defined in TS 38.304 [20], clause 5.2.4.3) just
prior to UE going into RRC_CONNECTED state. The UE indicates the value of medium and
high when being in Medium-mobility and High-mobility states respectively. Otherwise the UE
indicates the value normal.
ng-5G-S-TMSI-Part2
The leftmost 9 bits of 5G-S-TMSI.
registeredAMF
This field is used to transfer the GUAMI of the AMF where the UE is registered, as provided by
upper layers, see TS 23.003 [21].
selectedPLMN-Identity
Index of the PLMN or SNPN selected by the UE from the plmn-IdentityList or npn-
IdentityInfoList fields included in SIB1.

RRCSetupRequest

The RRCSetupRequest message is used to request the establishment of an RRC connection.
Signalling radio bearer: SRB0
RLC-SAP: TM
Logical channel: CCCH
Direction: UE to Network
RRCSetupRequest message

-- ASN1START
-- TAG-RRCSETUPREQUEST-START

| | |
|---|---|
| RRCSetupRequest ::= | SEQUENCE { |
| rrcSetupRequest | RRCSetupRequest-IEs |

}

| | |
|---|---|
| RRCSetupRequest-IEs ::= | SEQUENCE { |
| ue-Identity | InitialUE-Identity, |
| establishmentCause | EstablishmentCause, |
| spare | BIT STRING (SIZE (1)) |

}

| | |
|---|---|
| InitialUE-Identity ::= | CHOICE { |
| ng-5G-S-TMSI-Part1 | BIT STRING (SIZE (39)), |
| randomValue | BIT STRING (SIZE (39)) |

}

| | |
|---|---|
| EstablishmentCause ::= | ENUMERATED { |
| | emergency, highPriorityAccess, mt-Access, |
| | mo-Signalling, mo-Data, mo-VoiceCall, |
| | mo-VideoCall, mo-SMS, |
| | mps-PriorityAccess, |

mcs-PriorityAccess,

spare6, spare5, spare4, spare3, spare2,
spare1}

-- TAG-RRCSETUPREQUEST-STOP
-- ASN1STOP

RRCSetupRequest-IEs field descriptions

establishmentCause
Provides the establishment cause for the RRCSetupRequest in
accordance with the information received from upper layers.
gNB is not expected to reject an RRCSetupRequest due to
unknown cause value being used by the UE.
ue-Identity
UE identity included to facilitate
contention resolution by lower layers.
InitialUE-Identity field descriptions
ng-5G-S-TMSI-Part1
The rightmost 39 bits of 5G-S-TMSI.
randomValue
Integer value in the range 0 to 2³⁹ − 1.

[ . . . ]
RadioBearerConfig

The IE RadioBearerConfig is used to add, modify and release signalling and/or data radio bearers. Specifically, this IE carries the parameters for PDCP and, if applicable, SDAP entities for the radio bearers.

### RadioBearerConfig Information Element

-- ASN1START
-- TAG-RADIOBEARERCONFIG-START

| RadioBearerConfig ::= | SEQUENCE { | |
|---|---|---|
| srb-ToAddModList | SRB-ToAddModList | OPTIONAL, |

-- Cond HO-Conn

| | | |
|---|---|---|
| srb3-ToRelease | ENUMERATED{true} | OPTIONAL, |

-- Need N

| | | |
|---|---|---|
| drb-ToAddModList | DRB-ToAddModList | OPTIONAL, |

-- Cond HO-toNR

| | | |
|---|---|---|
| drb-ToReleaseList | DRB-ToReleaseList | OPTIONAL, -- |

Need N

| | | |
|---|---|---|
| securityConfig | SecurityConfig | OPTIONAL, -- |

Need M
...
}

| SRB-ToAddModList ::= | SEQUENCE (SIZE (1..2)) OF SRB-ToAddMod | |
|---|---|---|
| SRB-ToAddMod ::= | SEQUENCE { | |
| srb-Identity | SRB-Identity, | |
| reestablishPDCP | ENUMERATED{true} | OPTIONAL, |

-- Need N

| | |
|---|---|
| discardOnPDCP | ENUMERATED{true} |

OPTIONAL, -- Need N

| | | |
|---|---|---|
| pdcp-Config | PDCP-Config | OPTIONAL, -- |

Cond PDCP
...
}

| DRB-ToAddModList ::= | SEQUENCE (SIZE (1..maxDRB)) OF DRB-ToAddMod | |
|---|---|---|
| DRB-ToAddMod ::= | SEQUENCE { | |
| cnAssociation | CHOICE { | |
| eps-BearerIdentity | INTEGER (0..15), | |
| sdap-Config | SDAP-Config | |
| } | OPTIONAL, -- Cond DRBSetup | |
| drb-Identity | DRB-Identity, | |
| reestablishPDCP | ENUMERATED{true} | OPTIONAL, |

-- Need N

| | | |
|---|---|---|
| recoverPDCP | ENUMERATED{true} | OPTIONAL, |

-- Need N

| | | |
|---|---|---|
| pdcp-Config | PDCP-Config | OPTIONAL, -- |

```
Cond PDCP
  ...,
  [[
```

| | | |
|---|---|---|
| daps-Config-r16 | ENUMERATED{true} | OPTIONAL |

--Need N
]]
}

| | |
|---|---|
| DRB-ToReleaseList ::= | SEQUENCE (SIZE (1..maxDRB)) OF DRB-Identity |
| SecurityConfig ::= | SEQUENCE { |
| securityAlgorithmConfig | SecurityAlgorithmConfig |

OPTIONAL, -- Cond RBTermChange1

| | |
|---|---|
| keyToUse | ENUMERATED{master, secondary} |

OPTIONAL, -- Cond RBTermChange
...
}
-- TAG-RADIOBEARERCONFIG-STOP
-- ASN1STOP

DRB-ToAddMod field descriptions

cnAssociation
Indicates if the bearer is associated with the eps-bearerIdentity (when connected to EPC) or
sdap-Config (when connected to 5GC).
daps-Config
Indicates that the bearer is configured as DAPS bearer. This field is optional present, need N, in
case masterCellGroup includes ReconfigurationWithSync, MR-DC is not configured and
ethernetHeaderCompression is not configured for the DRB. Otherwise the field is absent.
drb-Identity
In case of DC, the DRB identity is unique within the scope of the UE, i.e. an MCG DRB cannot
use the same value as a split DRB. For a split DRB the same identity is used for the MCG and
SCG parts of the configuration.
eps-BearerIdentity
The EPS bearer ID determines the EPS bearer.
reestablishPDCP
Indicates that PDCP should be re-established. Network sets this to true whenever the security
key used for this radio bearer changes. Key change could for example be due to termination
point change for the bearer, reconfiguration with sync, resuming an RRC connection, or the first
reconfiguration after reestablishment. It is also applicable for LTE procedures when NR PDCP is
configured. Network doesn't include this field for DRB if the bearer is configured as DAPS
bearer. Network doesn't include this field for SRB if any DAPS bearer is configured.
recoverPDCP
Indicates that PDCP should perform recovery according to TS 38.323 [5]. Network doesn't
include this field if the bearer is configured as DAPS bearer.
sdap-Config
The SDAP configuration determines how to map QoS flows to DRBs when NR or E-UTRA
connects to the 5GC and presence/absence of UL/DL SDAP headers.

[ . . . ]
RLC-BearerConfig

The IE RLC-BearerConfig is used to configure an RLC entity, a corresponding logical channel in MAC and the linking to a PDCP entity (served radio bearer).

### RLC-BearerConfig Information Element

-- ASN1START
-- TAG-RLC-BEARERCONFIG-START

| | |
|---|---|
| RLC-BearerConfig ::= | SEQUENCE { |
| logicalChannelIdentity | LogicalChannelIdentity, |
| servedRadioBearer | CHOICE { |
| srb-Identity | SRB-Identity, |
| drb-Identity | DRB-Identity |

| | |
|---|---|
| } | OPTIONAL, -- Cond LCH- |

SetupOnly

| | | |
|---|---|---|
| reestablishRLC | ENUMERATED {true} | OPTIONAL, |

-- Need N

| | | |
|---|---|---|
| rlc-Config | RLC-Config | OPTIONAL, -- Cond |

LCH-Setup

| | |
|---|---|
| mac-LogicalChannelConfig | LogicalChannelConfig |

```
OPTIONAL, -- Cond LCH-Setup
  ...,
  [[
```

| | | |
|---|---|---|
| rlc-Config-v1610 | RLC-Config-v1610 | OPTIONAL -- |

Need R
]]
}
-- TAG-RLC-BEARERCONFIG-STOP
-- ASN1STOP

RLC-BearerConfig field descriptions

logicalChannelIdentity
ID used commonly for the MAC logical channel and for the RLC bearer.
reestablishRLC
Indicates that RLC should be re-established. Network sets this to true at least whenever the
security key used for the radio bearer associated with this RLC entity changes. For SRB2 and
DRBs, it is also set to true during the resumption of the RRC connection or the first
reconfiguration after reestablishment.
rlc-Config
Determines the RLC mode (UM, AM) and provides corresponding parameters. RLC mode
reconfiguration can only be performed by DRB release/addition or full configuration. The
network may configure rlc-Config-v1610 only when rlc-Config (without suffix) is set to am.
servedRadioBearer
Associates the RLC Bearer with an SRB or a DRB. The UE shall deliver DL RLC SDUs
received via the RLC entity of this RLC bearer to the PDCP entity of the servedRadioBearer.
Furthermore, the UE shall advertise and deliver uplink PDCP PDUs of the uplink PDCP entity of
the servedRadioBearer to the uplink RLC entity of this RLC bearer unless the uplink scheduling
restrictions (moreThanOneRLC in PDCP-Config and the restrictions in LogicalChannelConfig)
forbid it to do so.

SDAP-Config

The IE SDAP-Config is used to set the configurable SDAP parameters for a data radio bearer. All configured instances of SDAP-Config with the same value of pdu-Session correspond to the same SDAP entity as specified in TS 37.324 [24].

### SDAP-Config Information Element

-- ASN1START
-- TAG-SDAP-CONFIG-START

| | |
|---|---|
| SDAP-Config ::= | SEQUENCE { |
| pdu-Session | PDU-SessionID, |
| sdap-HeaderDL | ENUMERATED {present, |
| | absent}, |
| sdap-HeaderUL | ENUMERATED {present, |
| | absent}, |
| defaultDRB | BOOLEAN, |
| mappedQoS-FlowsToAdd | SEQUENCE (SIZE |
| | (1..maxNrofQFIs)) OF QFI |

OPTIONAL, -- Need N

| | |
|---|---|
| mappedQoS-FlowsToRelease | SEQUENCE (SIZE |
| | (1..maxNrofQFIs)) OF QFI |

OPTIONAL, -- Need N
...
}

| | |
|---|---|
| QFI ::= | INTEGER (0..maxQFI) |
| PDU-SessionID ::= | INTEGER (0..255) |

-- TAG-SDAP-CONFIG-STOP
-- ASN1STOP

SDAP-Config field descriptions

defaultDRB
Indicates whether or not this is the default DRB for this PDU session. Among all configured
instances of SDAP-Config with the same value of pdu-Session, this field shall be set to true in at
most one instance of SDAP-Config and to false in all other instances.
mappedQoS-FlowsToAdd
Indicates the list of QFIs of UL QoS flows of the PDU session to be additionally mapped to this
DRB. A QFI value can be included at most once in all configured instances of SDAP-Config
with the same value of pdu-Session. For QoS flow remapping, the QFI value of the remapped
QoS flow is only included in mappedQoS-FlowsToAdd in sdap-Config corresponding to the new
DRB and not included in mappedQoS-FlowsToRelease in sdap-Config corresponding to the old
DRB.
mappedQoS-FlowsToRelease
Indicates the list of QFIs of QoS flows of the PDU session to be released from existing QoS flow
to DRB mapping of this DRB.
pdu-Session
Identity of the PDU session whose QoS flows are mapped to the DRB.
sdap-HeaderUL
Indicates whether or not a SDAP header is present for UL data on this DRB. The field cannot be
changed after a DRB is established. The network sets this field to present if the field defaultDRB
is set to true.
sdap-HeaderDL
Indicates whether or not a SDAP header is present for DL data on this DRB. The field cannot be
changed after a DRB is established.

9.2.1 Default SRB Configurations

Parameters

| | Value | | | Semantics | |
|---|---|---|---|---|---|
| Name | SRB1 | SRB2 | SRB3 | description | Ver |
| PDCP-Config | | | | | |
| >t-Reordering | infinity | | | | |
| RLC-Config CHOICE | Am | | | | |
| ul-RLC-Config | | | | | |
| >sn-FieldLength | size12 | | | | |
| >t-PollRetransmit | ms45 | | | | |
| >pollPDU | infinity | | | | |
| >pollByte | infinity | | | | |
| >maxRetxThreshold | t8 | | | | |
| dl-RLC-Config | | | | | |
| >sn-FieldLength | size12 | | | | |
| PDCP-Config | | | | | |
| >t-Reordering | infinity | | | | |
| >t-Reassembly | ms35 | | | | |
| >t-StatusProhibit | ms0 | | | | |
| logicalChannelIdentity | 1 | 2 | 3 | | |
| LogicalChannelConfig | | | | | |
| >priority | 1 | 3 | 1 | | |

| | |
|---|---|
| >prioritisedBitRate | infinity |
| >logicalChannelGroup | 0 |

According to the normal RRC connection establishment procedure specified in 3GPP TS 38.331, a RRCSetupRequest message is transmitted on SRB0 to a gNB by a UE. In response to reception of the RRCSetupRequest message, gNB will transmit a RRCSetup message on SRB0 to the UE to establish SRB1. The UE then replies with a RRCSetupComplete message on SRB1. The RRCSetup message includes IE RadioBearerConfig associated with SRB1, while IE RLC-BearerConfig associated with SRB1 is included in the default SRB configurations pre-defined in 3GPP TS 38.331. SRB2 and SRB3 may be established via a RRC reconfiguration procedure after AS security has been activated.

3GPP R2-200847 gives an overview on study aspects of UE-to-Network relay, focusing on the solutions for L2 UE-to-Network relay. FIG. 2 (not shown) in 3GPP R2-200847 describes a protocol stack for layer 2 UE-to-Network relay. Basically, there are two legs in the protocol stack i.e. a PC5 (or SL) leg between a Remote UE and a Relay UE as well as a Uu leg between the Relay UE and the gNB. Regarding SRB and DRB configurations, 3GPP R2-2008047 raises the following proposals:
Proposal 3: For Uu SRB0 of the Remote UE, related RLC bearer parameters on PC5 and Uu link are predefined by specification.
Proposal 4: For Uu SRB1 and Uu SRB2 of the Remote UE, related PDCP and RLC bearer parameters on PC5 and Uu link can be configured by gNB.
Proposal 5: For Uu DRB of the Remote UE, related Uu SDAP, Uu PDCP and RLC bearer parameters on PC5 and Uu link can be configured by gNB.

Regarding bearer mappings at remote UE and relay UE (referring to FIG. 3 (not shown) in 3GPP R2-200847), 3GPP R2-2008047 raises the following proposals:
Proposal 6: For remote UE, only 1 to 1 mapping between Uu PDCP entity and SL RLC bearer is supported.
Proposal 7: For relay UE, both 1 to 1 mapping and N to 1 mapping between SL RLC bearer and Uu RLC bearer are supported.
Proposal 8: In L2 UE-to-Network relay, all bearer/LCH mappings at remote UE and relay UE are configured by the gNB.

The following discussion is an example how gNB can configure the bearer mapping:
The Bearer ID, which identifies the Remote UE's Uu DRB, can be added in the adaptation layer header for the bearer mapping at relay UE and gNB, in case of N:1 mapping.
At remote UE, the mapping table between Uu DRB ID to SL RLC ID is configured by gNB.
At relay UE, the following mapping tables can be configured by gNB: 1) SL RLC ID to Uu RLC ID, for UL; 2) Bearer ID in adaptation header to SL RLC ID, for DL.

However, it is also possible to support N to 1 mapping between Uu PDCP entity and SL RLC bearer for remote UE.

Regarding the adaptation layers (referring to FIG. 3 (not shown) in 3GPP R2-2008047), 3GPP R2-2008047 raises the following proposals:
Proposal 9: No adaptation layer is needed in the SL hop for UE-to-Network relay.
Proposal 10: Adaptation layer above Uu RLC is needed in Uu hop for UE-to-Network relay.
Proposal 11: Bearer ID of the remote UE's DRB should be added in adaptation layer, to support N:1 mapping between SL RLC bearer to Uu RLC bearer at relay UE.

If multiple remote UEs can access the gNB via the same relay UE, a local UE identifier is needed between relay UE and gNB for distinguishing remote UEs and the relay UE. FIG. 6 (not shown) in 3GPP R2-2008047 illustrates data routing between the Remote UE and the gNB via the Relay UE as discussed below:

Step 1: The gNB Knows which UE (i.e., Relay UE, Remote UE1 or Remote UE2) the DL Data Belongs to

The gNB establishes higher L2 entities (i.e., Uu SDAP and Uu PDCP) for the DRBs of each UE sharing the same lower L2 entities (i.e., RLC and MAC) and gNB maintains the UE context including the UE local identifier of each UE. When DL data arrives from one PDCP entity, the gNB knows which UE the PDCP entity belongs to. Correspondingly, the gNB is able to determine the local UE identifier to be included in the adaptation layer header. Then gNB sends the PDCP PDU together with the Adaptation layer header to relay UE.

Step 2: Relay UE Receives the Data and Determines which Remote UE the Data Belongs to

Previously, the relay UE and gNB have exchanged the local UE identifier, which means relay UE and gNB can use it as a reference to the dedicated remote UE or the relay UE. Upon receiving the data from gNB, the relay UE is able to interpret the adaptation layer header and get the included information, i.e., local UE identifier. Based on the local UE identifier, the relay UE is able to know the associated remote UE or the relay UE itself.

For uplink data transmission, the whole procedure is similar, i.e., the relay UE receives uplink PDCP PDU via the SL unicast from the remote UE or the relay UE itself. Relay UE is able to determine the local UE identifier based on the configuration previously provided by the gNB. Then relay UE adds adaptation layer header including the local UE identifier to the received PDCP PDU. At last, relay UE transmits the PDCP PDU together with adaptation layer header to gNB.

Accordingly, the following proposals are provided:
Proposal 12: For UE-to-Network L2 relay, a local identifier, included in adaptation layer header, is used for routing.
Proposal 13: The local identifier is allocated by a relay UE and uniquely identify one remote UE in the scope of the relay UE.

Furthermore, FIG. 7 (not shown) in 3GPP R2-2008047 describes how a Remote UE establishes a RRC connection with gNB via a Relay UE as follows:

Step 1: Relay UE Discovery

In general, we think the basic discovery procedure defined in LTE can be reused as well as the Relay UE (re)selection criteria.

Step 2: Unicast Connection Establishment

The unicast connection between Remote UE and Relay UE should be established. The details are pending on SA2.

Step 2a/2b: Unified Access Control

As discussed in the following, the access control on remote UE is supported in this procedure. The relay UE may provide UAC parameters to remote UE when SL unicast connection is established. For example, it can be transmitted via the SL RRC message as dedicated parameters or included in SIB1 as a RRC container.

Upon reception of the UAC parameters, the remote UE performs the Access Control by itself. If the access is allowed, the remote UE triggers RRC Setup procedure with gNB via relay UE.

Step 3: Remote UE Sends Uu RRCSetupRequest to gNB Via Relay UE

Remote UE transmits RRCSetupRequest message to relay UE so that relay UE could relay this message to gNB. In details, the remote UE could transmit RRCSetupRequest message to relay UE via a default SL RLC bearer, i.e., a default SL RLC bearer should be introduced to support the transmission of SRB0 related messages, e.g., RRCSetupRequest, RRCSetup.

Upon reception of the RLC SDU encapsulating RRCSetupRequest via the default SL RLC bearer between the remote UE, the relay UE is able to know it is a new remote UE. Then the relay UE allocates a local identifier for the remote UE and store it as the context of the remote UE together with the unicast connection ID, i.e., SRC L2 ID, DST L2 ID.

Further, relay UE forwards the received RRCSetupRequest message to gNB, e.g. via a default Uu RLC bearer. In details, relay UE adds the adaptation layer header including local identifier to the received RRCSetupRequest message and then transmits the adaptation layer PDU to gNB. The default Uu RLC bearer is introduced to carry SRB0 related messages in Uu.

Step 4: gNB Transmits RRCSetup Message to Remote UE Via Relay UE

If gNB accepts the request from remote UE, it responses the RRCSetup message to remote UE via relay UE. In details, the gNB adds adaptation layer header including the local identifier to the RRC PDU and transmits this adaptation layer PDU to relay UE.

Upon reception of the adaptation layer PDU encapsulating RRCSetup message, the relay UE acquires the local identifier from the adaptation layer header and determines the linked remote UE based on this local identifier. Then the relay UE is able to relay the received RRC PDU to remote UE.

Step 5: Remote UE Transmits RRCSetupComplete Message to gNB Via Relay UE

Remote UE generates PDCP PDU encapsulating the RRCSetupComplete message and transmits this PDCP PDU to relay UE via sidelink unicast connection. Upon reception of the PDCP PDU encapsulating the RRCSetupComplete message, the relay UE is able to determine the associated local id. Then relay UE adds adaptation layer header including the local identifier to the PDCP PDU and sends it to gNB.

The protocol stack applied in the RRCSetupComplete message transmission procedure is illustrated in FIG. 5 (not shown) in 3GPP R2-2008047.

Step 6: Initial AS Security Activation Procedure Between Remote UE and gNB

Initial AS Security Activation is performed between remote UE and gNB via Relay UE.

Step 7: RRC Reconfiguration Procedure Between Remote UE and gNB

Similarly, the RRC Reconfiguration is performed between remote UE and gNB via relay UE.

As proposed by 3GPP R2-2008047, a local UE identifier (used to identify a relay UE or a remote UE) may be included in the adaptation layer header for distinguishing UEs (Remote UEs and optionally the Relay UE) and a bearer ID of the concerned UE's DRB may be added in adaptation layer to support N:1 mapping between SL RLC bearer to Uu RLC bearer at the Relay UE. It is possible that a Uu RLC bearer is occupied by only one UE. In this situation, the local UE identifier is not needed. In other words, the adaptation layer header may only include the bearer ID field.

It is possible that initially only traffic of the Relay UE is transmitted on a Uu RLC bearer between the Relay UE and the gNB. In this situation, no adaptation layer header is needed in this situation. When a Remote UE's traffic is later mapped to the Uu RLC bearer, the adaptation layer header needs to be added. At the time when an adaptation layer header is configured or added to a Uu RLC bearer, there may have been some Relay UE's PDCP PDUs without adaptation layer header still stored in Uu RLC layer waiting for transmission. In this situation, gNB cannot know whether a PDU received from Uu RLC layer has an adaptation layer header or not after the Remote UE's traffic is configured to map to the Uu RLC bearer or after the adaptation layer header is configured or added to the Uu RLC bearer.

As a result, PDU decoding error may occur to those PDUs if gNB decodes them assuming the adaptation layer header is present in each of those PDUs, which may result in PDU loss. Similar problem may occur when the Remote UE's traffic is removed from the Uu RLC bearer, wherein the adaptation layer header is not needed and thus may be removed. To solve the problem, the Relay UE may transmit information to gNB on the Uu RLC bearer to indicate the adaptation layer header is added to or removed from PDUs transmitted following this information. gNB can then correctly decode a PDU received after this information because the gNB knows whether the adaptation layer header is present in the PDU or not. In one embodiment, the information is transmitted via a control PDU. A field in the control PDU may indicate the adaptation layer header is added or removed.

As mentioned above, the adaptation layer header may only include a field of a bearer ID if a Uu RLC bearer is occupied by only one Remote UE. Therefore, the information sent to gNB may indicate the adaptation layer header is changed. For example, a field of the local UE identifier is added to or removed from the adaptation layer header.

To distinguish a control PDU from a data PDU, there is a need to include one field in each PDU to indicate whether it is a control PDU or a data PDU. Therefore, each data PDU may include an adaptation layer header, which includes at least one field to indicate whether it is a control PDU or a data PDU.

In view of the above, a general description of this solution is that the Relay UE transmits information to gNB on a Uu RLC bearer to indicate an adaptation layer header is changed. In one embodiment, the information is transmitted via a control PDU. An adaptation layer header may be present in each PDU. One field in the adaptation layer header of each PDU indicates whether it is a control PDU or a data PDU. A field in the control PDU may indicate the adaptation layer header is changed. For example, the information may indicate a field of a local UE identifier is added to or removed from the adaptation layer header and/or a field of a bearer ID is added to or removed from the adaptation layer header.

Another alternative solution is for the Relay UE retransmits those pending PDUs with the new adaptation layer header configuration after the adaptation layer header change. With this solution, PDU loss may also be avoided.

Another alternative is to specify two kinds of radio bearer or Uu RLC bearer i.e. one kind of radio bearer or Uu RLC bearer is associated with an adaptation layer configured with header (i.e. header of the adaptation layer is present) and the other kind of radio bearer or Uu RLC bearer is associated with an adaptation layer configured with no header (i.e. header of the adaptation layer is absent). In the meantime, the presence of an adaptation layer header cannot be changed to absence after the radio bearer is established (or before the radio bearer is released), and the absence of an adaptation layer header cannot be changed to presence after the radio bearer is established (or before the radio bearer is released).

Given this alternative, a QoS flow may be remapped from one kind of radio bearer to the other kind of radio bearer when needed. In case radio bearer remapping occurs for uplink transmission, the remote UE/the relay UE may transmit an end-marker control PDU to the gNB. If it occurs for downlink transmission, the gNB may transmit an end-marker control PDU to the remote UE/the relay UE. The end-marker control PDU could be generated by a SDAP layer or entity. Alternatively, the end-marker control PDU could be generated by an adaptation layer or entity.

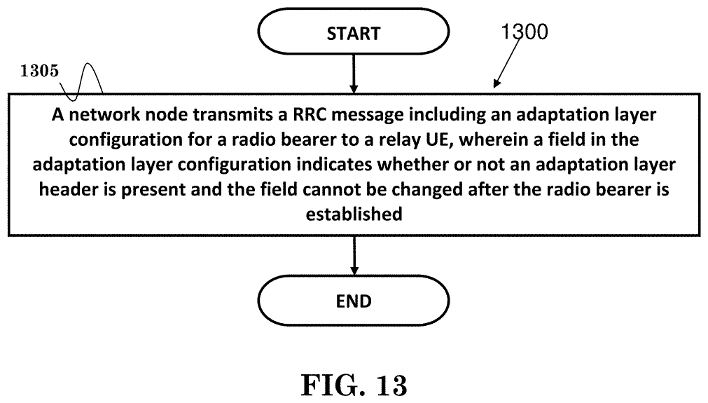

FIG. 13 is a flow chart 1300 illustrating a method for adaptation layer configuration, wherein an adaptation layer is above a Uu RLC layer and below a PDCP layer, according to one exemplary embodiment. In step 1305, a network node transmits a RRC message including an adaptation layer configuration for a radio bearer to a relay UE, wherein a field in the adaptation layer configuration indicates whether or not an adaptation layer header is present and the field cannot be changed after the radio bearer is established.

In one embodiment, the RRC message may also include a Uu RLC bearer configuration, a PDCP configuration, and/or a SDAP configuration for the radio bearer. The RRC message may also include an identifier of the radio bearer. The RRC message may further include a radio bearer configuration of the radio bearer which contains the Uu RLC bearer configuration, the PDCP configuration, and/or the SDAP configuration.

In one embodiment, the adaptation layer header may include a field of a local UE identifier and/or a field of a bearer ID. The adaptation layer header may also include a field indicating whether an adaptation layer PDU is a control PDU or a data PDU. The control PDU may be an end-marker control PDU.

In one embodiment, a SDAP header of a SDAP PDU may include an identifier of a QoS flow. The radio bearer could be used for uplink or downlink transmission. The relay UE could be used to forward uplink transmission from a remote UE to the network node and/or downlink transmission from the network node to the remote UE. The radio bearer may be a signalling radio bearer (SRB) or a data radio bearer (DRB).

In one embodiment, the RRC message may be a RRC reconfiguration message. The field in the adaptation layer configuration indicates whether or not the adaptation layer header may be present for the radio bearer or a RLC bearer mapped to the radio bearer. The RLC bearer could be configured by the Uu RLC bearer configuration. The SDAP PDU could be sent on the radio bearer.

Referring back to FIGS. 3 and 4, in one exemplary embodiment of a method for adaptation layer configuration, wherein an adaptation layer is above a Uu RLC layer and below a PDCP layer, the network node 300 includes a program code 312 stored in the memory 310. The CPU 308 could execute program code 312 to enable the network node to transmit a RRC message including an adaptation layer configuration for a radio bearer to a relay UE, wherein a field in the adaptation layer configuration indicates whether or not an adaptation layer header is present and the field cannot be changed after the radio bearer is established. Furthermore, the CPU 308 can execute the program code 312 to perform all of the above-described actions and steps or others described herein.

Another way to describe the solution is that each Uu RLC bearer could be configured with a presence of adaptation layer header and the presence of adaptation layer header could not be changed to an absence of adaptation layer header after this Uu RLC bearer is established or before this Uu RLC bearer is released. Similarly, each Uu RLC bearer could be configured with an absence of adaptation layer header and the absence of adaptation layer header could not be changed to a presence of adaptation layer header after this Uu RLC bearer is established or before this Uu RLC bearer is released. When gNB configures the Relay UE to establish a Uu RLC bearer (via e.g. RRC reconfiguration message), gNB could configure a presence of adaptation layer header or an absence of adaptation layer header for the Uu RLC bearer. More specifically, gNB may not (be allowed to) reconfigure the Uu RLC bearer from the presence of adaptation layer header to the absence of adaptation layer header. More specifically, gNB may not (be allowed to) reconfigure the Uu RLC bearer from the absence of adaptation layer header to the presence of adaptation layer header.

When the Relay UE has only its own traffic for transmission to gNB, gNB could configure the Relay UE to establish a first Uu RLC bearer and configure the first Uu RLC bearer without applying adaptation layer header. When the Relay UE has traffic from the Remote UE and the traffic of the Remote UE is to be sent to gNB, gNB could configure the Relay UE to establish a second Uu RLC bearer and configure the second Uu RLC bearer with applying adaptation layer header. When all pending traffic on the first Uu RLC bearer has been sent to gNB, gNB could reconfigure the Relay UE to release the first Uu RLC bearer (for saving usage of logical channel identity range). After the second Uu RLC bearer is established, the Relay UE could continue transmission of the traffic to be sent on the first Uu RLC bearer. With this solution, the state transition of presenting or absenting adaptation layer header on the Uu RLC bearer will not occur before the Uu RLC bearer is released. Thus, it is not possible for gNB to incorrectly decode a received PDU including an adaptation layer header on a Uu RLC bearer but the Uu RLC bearer is configured with absence of the adaptation layer header. Similarly, gNB would not incorrectly decode a received PDU not including an adaptation layer header on a Uu RLC bearer but the Uu RLC bearer is configured with presence of the adaptation layer header.

Since the SRBs of a Remote UE may also share the same lower L2 entities (i.e., RLC and MAC) or Uu RLC bearer with the Relay UE, the similar problem may also occur and thus the above solutions for DRBs may also be applicable to SRBs.

The above descriptions are generally concerned about uplink traffic transmitted to the gNB. Downlink traffic received from the gNB may also encounter similar problems and thus the above solutions may also be applicable to downlink traffic. For example, the gNB may transmit information to the Relay UE on a Uu RLC bearer to indicate an adaptation layer header is changed.

In one embodiment, the information is transmitted via a control PDU. An adaptation layer header may be present in each PDU. One field in the adaptation layer header of each PDU indicates whether it is a control PDU or a data PDU. A field in the control PDU may indicate the adaptation layer header is changed. For example, the information may indicate a field of a local UE identifier is added to or removed from the adaptation layer header and/or a field of a bearer ID is added to or removed from the adaptation layer header.

In one embodiment, gNB may provide an adaptation layer configuration to the Relay UE when the adaptation layer configuration changes. The adaptation layer configuration may include mapping between SL (or PC5) RLC bearer to Uu RLC bearer. The SL (or PC5) RLC bearer may be associated with a Remote UE. The adaptation layer configuration may also include information indicating an adaptation layer header configuration change. For example, a field of a local UE identifier is added to or removed from the adaptation layer header and/or a field of a bearer ID is added to or removed from the adaptation layer header.

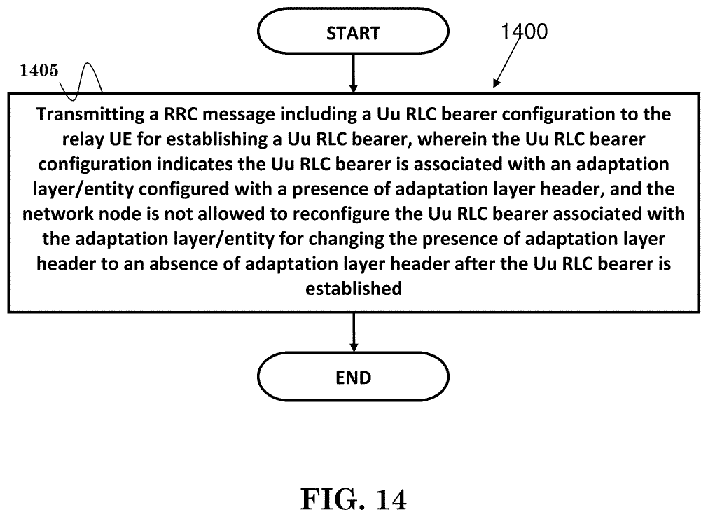

FIG. 14 is a flow chart 1400 illustrates a method for a network node to configure one Uu RLC bearer for a relay UE according to one exemplary embodiment. In step 1405, the network node transmits a RRC message including a Uu RLC bearer configuration to the relay UE for establishing a Uu RLC bearer, wherein the Uu RLC bearer configuration indicates the Uu RLC bearer is associated with an adaptation layer/entity configured with a presence of adaptation layer header, and the network node is not allowed to reconfigure the Uu RLC bearer associated with the adaptation layer/entity for changing the presence of adaptation layer header to an absence of adaptation layer header after the Uu RLC bearer is established.

Referring back to FIGS. 3 and 4, in one exemplary embodiment of a method for a network node to configure one Uu RLC bearer for a relay UE, the network node 300 includes a program code 312 stored in the memory 310. The CPU 308 could execute program code 312 to enable the network node to transmit a RRC message including a Uu RLC bearer configuration to the relay UE for establishing a Uu RLC bearer, wherein the Uu RLC bearer configuration indicates the Uu RLC bearer is associated with an adaptation layer/entity configured with a presence of adaptation layer header, and the network node is not allowed to reconfigure the Uu RLC bearer associated with the adaptation layer/entity for changing the presence of adaptation layer header to an absence of adaptation layer header after the Uu RLC bearer is established. Furthermore, the CPU 308 can execute the program code 312 to perform all of the above-described actions and steps or others described herein.

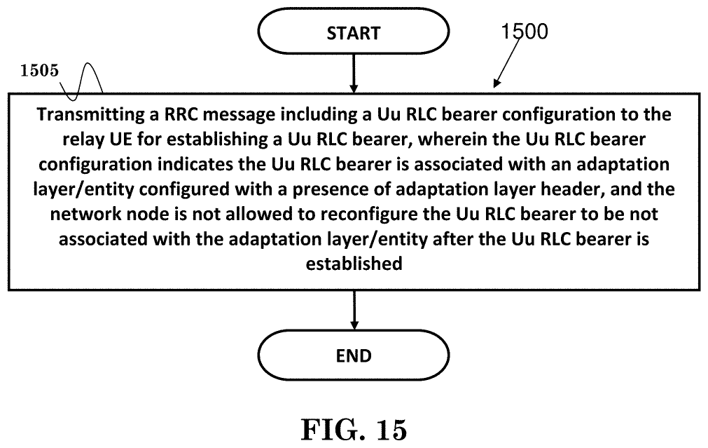

FIG. 15 is a flow chart 1500 illustrates a method for a network node to configure one Uu RLC bearer for a relay UE according to one exemplary embodiment. In step 1505, the network node transmits a RRC message including a Uu RLC bearer configuration to the relay UE for establishing a Uu RLC bearer, wherein the Uu RLC bearer configuration indicates the Uu RLC bearer is associated with an adaptation layer/entity configured with a presence of adaptation layer header, and the network node is not allowed to reconfigure the Uu RLC bearer to be not associated with the adaptation layer/entity after the Uu RLC bearer is established.

Referring back to FIGS. 3 and 4, in one exemplary embodiment of a method for a network node to configure one Uu RLC bearer for a relay UE, the network node 300 includes a program code 312 stored in the memory 310. The CPU 308 could execute program code 312 to enable the network node to transmit a RRC message including a Uu RLC bearer configuration to the relay UE for establishing a Uu RLC bearer, wherein the Uu RLC bearer configuration indicates the Uu RLC bearer is associated with an adaptation layer/entity configured with a presence of adaptation layer header, and the network node is not allowed to reconfigure the Uu RLC bearer to be not associated with the adaptation layer/entity after the Uu RLC bearer is established. Furthermore, the CPU 308 can execute the program code 312 to perform all of the above-described actions and steps or others described herein.

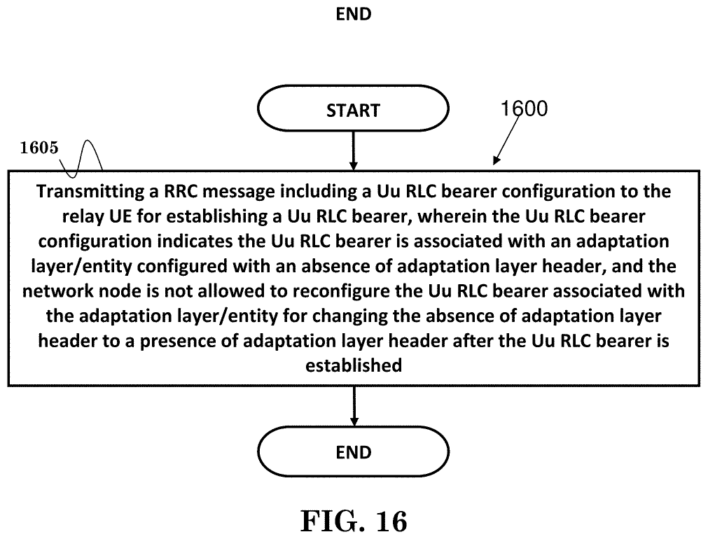

FIG. 16 is a flow chart 1600 illustrates a method for a network node to configure one Uu RLC bearer for a relay UE according to one exemplary embodiment. In step 1605, the network node transmits a RRC message including a Uu RLC bearer configuration to the relay UE for establishing a Uu RLC bearer, wherein the Uu RLC bearer configuration indicates the Uu RLC bearer is associated with an adaptation layer/entity configured with an absence of adaptation layer header, and the network node is not allowed to reconfigure the Uu RLC bearer associated with the adaptation layer/entity for changing the absence of adaptation layer header to a presence of adaptation layer header after the Uu RLC bearer is established.

Referring back to FIGS. 3 and 4, in one exemplary embodiment, the network node 300 includes a program code 312 stored in the memory 310. The CPU 308 could execute program code 312 to enable the network node to transmitting a RRC message including a Uu RLC bearer configuration to the relay UE for establishing a Uu RLC bearer, wherein the Uu RLC bearer configuration indicates the Uu RLC bearer is associated with an adaptation layer/entity configured with an absence of adaptation layer header, and the network node is not allowed to reconfigure the Uu RLC bearer associated with the adaptation layer/entity for changing the absence of adaptation layer header to a presence of adaptation layer header after the Uu RLC bearer is established. Furthermore, the CPU 308 can execute the program code 312 to perform all of the above-described actions and steps or others described herein.

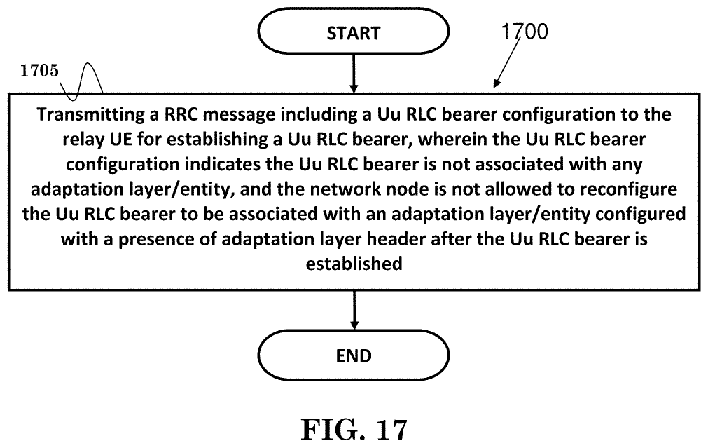

FIG. 17 is a flow chart 1700 illustrates a method for a network node to configure one Uu RLC bearer for a relay UE according to one exemplary embodiment. In step 1705, the network node transmits a RRC message including a Uu RLC bearer configuration to the relay UE for establishing a Uu RLC bearer, wherein the Uu RLC bearer configuration indicates the Uu RLC bearer is not associated with any adaptation layer/entity, and the network node is not allowed to reconfigure the Uu RLC bearer to be associated with an adaptation layer/entity configured with a presence of adaptation layer header after the Uu RLC bearer is established.

Referring back to FIGS. 3 and 4, in one exemplary embodiment of a method for a network node to configure one Uu RLC bearer for a relay UE, the network node 300 includes a program code 312 stored in the memory 310. The CPU 308 could execute program code 312 to enable the network node to transmit a RRC message including a Uu RLC bearer configuration to the relay UE for establishing a Uu RLC bearer, wherein the Uu RLC bearer configuration indicates the Uu RLC bearer is not associated with any adaptation layer/entity, and the network node is not allowed to reconfigure the Uu RLC bearer to be associated with an adaptation layer/entity configured with a presence of adaptation layer header after the Uu RLC bearer is established. Furthermore, the CPU 308 can execute the program code 312 to perform all of the above-described actions and steps or others described herein.

In the context of the embodiments illustrated in FIGS. 14-17 and described above, in one embodiment, the network node could configure the relay UE to establish a Uu DRB, wherein the Uu DRB is configured with a presence of SDAP header. The network node could also configure the relay UE to establish a Uu DRB, wherein the Uu DRB is configured with an absence of SDAP header.

In one embodiment, the RRC message may include a Uu DRB configuration, and the Uu DRB configuration could configure the establishment of the Uu DRB. The RRC message or the Uu DRB configuration could configure the Uu DRB with the presence of SDAP header or the absence of SDAP header. The Uu RLC bearer could be mapped to the Uu DRB.

In one embodiment, traffic or signaling transfer between a remote UE and the network node over the Uu RLC bearer could be conducted via the relay UE. A PC5 link could be used for the traffic or signaling transfer between the remote UE and the relay UE. A Uu link could be used for the traffic or signaling transfer between the relay UE and the network node. The RRC message could be a RRC reconfiguration message. The network node may be a base station, e.g. gNB.

In one embodiment, the adaptation layer header may include an identifier of the remote UE. The adaptation layer header may also include an identifier of a radio bearer for the remote UE. The SDAP header may include an identifier of a QoS flow. The adaptation layer or entity may be above a RLC layer and below a PDCP layer.

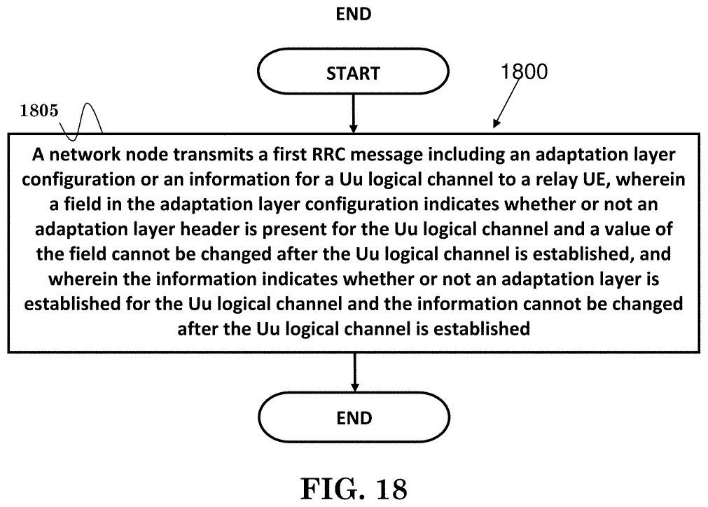

FIG. 18 is a flow chart 1800 illustrates a method for adaptation layer configuration, wherein an adaptation layer is above a Uu RLC layer and below a Uu PDCP layer, according to one exemplary embodiment. In step 1805, a network node transmitting a first RRC message including an adaptation layer configuration or an information for a Uu logical channel to a relay UE, wherein a field in the adaptation layer configuration indicates whether or not an adaptation layer header is present for the Uu logical channel and a value of the field cannot be changed after the Uu logical channel is established, and wherein the information indicates whether or not an adaptation layer is established for the Uu logical channel and the information cannot be changed after the Uu logical channel is established.

In one embodiment, the adaptation layer header may include a field of a local UE identifier and/or a field of a radio bearer ID. The uplink data from a remote UE could be forwarded by the relay UE to the network node over the Uu logical channel, and/or downlink data from the network node could be forwarded by the relay UE to the remote UE over the Uu logical channel.

In one embodiment, the network node could transmit a second RRC message to the relay UE to establish a Uu DRB, wherein the second RRC message may include a SDAP layer configuration for the Uu DRB, and a field in the SDAP layer configuration could indicate whether a SDAP header is present for the Uu DRB, and a value of the field in the SDAP layer configuration may not be changed after the Uu DRB is established.

In one embodiment, uplink data of the relay UE could be transmitted by the relay UE to the network node over the Uu DRB, and/or downlink data for the relay UE could be received by the relay UE from the network node over the Uu DRB. A SDAP header of the SDAP layer includes a field of a QoS flow identity.

Referring back to FIGS. 3 and 4, in one exemplary embodiment a method for adaptation layer configuration, wherein an adaptation layer is above a Uu RLC layer and below a Uu PDCP layer, the network node 300 includes a program code 312 stored in the memory 310. The CPU 308 could execute program code 312 to enable the network node to transmit a first RRC message including an adaptation layer configuration or an information for a Uu logical channel to a relay UE, wherein a field in the adaptation layer configuration indicates whether or not an adaptation layer header is present for the Uu logical channel and a value of the field cannot be changed after the Uu logical channel is established, and wherein the information indicates whether or not an adaptation layer is established for the Uu logical channel and the information cannot be changed after the Uu logical channel is established. Furthermore, the CPU 308 can execute the program code 312 to perform all of the above-described actions and steps or others described herein.

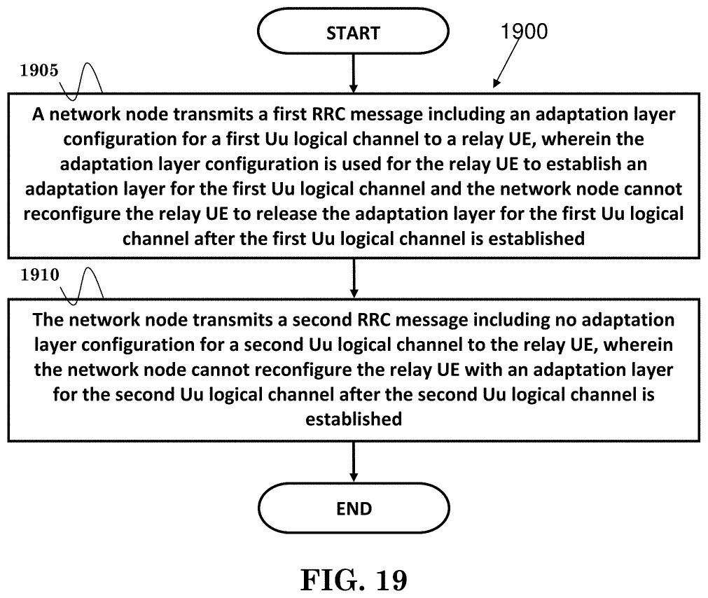

FIG. 19 is a flow chart 1900 illustrates a method for adaptation layer configuration, wherein an adaptation layer is above a Uu RLC layer and below a Uu PDCP layer according to one exemplary embodiment. In step 1905, a network node transmits a first RRC message including an adaptation layer configuration for a first Uu logical channel to a relay UE, wherein the adaptation layer configuration is used for the relay UE to establish an adaptation layer for the first Uu logical channel and the network node cannot reconfigure the relay UE to release the adaptation layer for the first Uu logical channel after the first Uu logical channel is established. In step 1910, the network node transmits a second RRC message including no adaptation layer configuration for a second Uu logical channel to the relay UE, wherein the network node cannot reconfigure the relay UE with an adaptation layer for the second Uu logical channel after the second Uu logical channel is established.

In one embodiment, an adaptation layer header is always present for the first Uu logical channel after the first Uu logical channel is established, and the adaptation layer header includes a field of a local UE identifier and/or a field of a radio bearer ID. Uplink data from a remote UE could be forwarded by the relay UE to the network node over the Uu logical channel, and/or downlink data from the network node could be forwarded by the relay UE to the remote UE over the Uu logical channel.

In one embodiment, the network node could transmit a third RRC message to the relay UE to establish a Uu DRB, wherein the third RRC message may include a SDAP layer configuration for the Uu DRB, and a field in the SDAP layer configuration could indicate whether a SDAP header is present for the Uu DRB, and a value of the field in the SDAP layer configuration may not be changed after the Uu DRB is established. Uplink data of the relay UE could be transmitted by the relay UE to the network node over the Uu DRB, and/or downlink data for the relay UE could be received by the relay UE from the network node over the Uu DRB. A SDAP header of the SDAP layer may include a field of a QoS flow identity.

Referring back to FIGS. 3 and 4, in one exemplary embodiment of a method for adaptation layer configuration, wherein an adaptation layer is above a Uu RLC layer and below a Uu PDCP layer, the network node 300 includes a program code 312 stored in the memory 310. The CPU 308 could execute program code 312 to enable the network node (i) to transmit a first RRC message including an adaptation layer configuration for a first Uu logical channel to a relay UE, wherein the adaptation layer configuration is used for the relay UE to establish an adaptation layer for the first Uu logical channel and the network node cannot reconfigure the relay UE to release the adaptation layer for the first Uu logical channel after the first Uu logical channel is established, and (ii) to transmit a second RRC message including no adaptation layer configuration for a second Uu logical channel to the relay UE, wherein the network node cannot reconfigure the relay UE with an adaptation layer for the second Uu logical channel after the second Uu logical channel is established. Furthermore, the CPU 308 can execute the program code 312 to perform all of the above-described actions and steps or others described herein.

Various aspects of the disclosure have been described above. It should be apparent that the teachings herein could be embodied in a wide variety of forms and that any specific structure, function, or both being disclosed herein is merely representative. Based on the teachings herein one skilled in the art should appreciate that an aspect disclosed herein could be implemented independently of any other aspects and that two or more of these aspects could be combined in various ways. For example, an apparatus could be implemented or a method could be practiced using any number of the aspects set forth herein. In addition, such an apparatus could be implemented or such a method could be practiced using other structure, functionality, or structure and functionality in addition to or other than one or more of the aspects set forth herein. As an example of some of the above concepts, in some aspects concurrent channels could be established based on pulse repetition frequencies. In some aspects concurrent channels could be established based on pulse position or offsets. In some aspects concurrent channels could be established based on time hopping sequences. In some aspects concurrent channels could be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for adaptation layer configuration, wherein an adaptation layer is above a Uu Radio Link Control (RLC) layer and below a Uu Packet Data Convergence Protocol (PDCP) layer, comprising:
a network node transmits a first Radio Resource Control (RRC) message including an adaptation layer configuration or an information for a Uu logical channel to a relay User Equipment (UE), wherein a field in the adaptation layer configuration indicates whether or not an adaptation layer header is present for the Uu logical channel and a value of the field cannot be changed after the Uu logical channel is established, and wherein the information indicates whether or not an adaptation layer is established for the Uu logical channel and the information cannot be changed after the Uu logical channel is established.

2. The method of claim 1, wherein the adaptation layer header includes a field of a local UE identifier and/or a field of a radio bearer identity (ID).

3. The method of claim 1, wherein uplink data from a remote UE is forwarded by the relay UE to the network node over the Uu logical channel and/or downlink data from the network node is forwarded by the relay UE to the remote UE over the Uu logical channel.

4. The method of claim 1, further comprising:
the network node transmits a second RRC message to the relay UE to establish a Uu Data Radio Bearer (DRB), wherein the second RRC message includes a Service Data Adaptation Protocol (SDAP) layer configuration for the Uu DRB, and a field in the SDAP layer configuration indicates whether a SDAP header is present for the Uu DRB and a value of the field in the SDAP layer configuration cannot be changed after the Uu DRB is established.

5. The method of claim 4, wherein uplink data of the relay UE is transmitted by the relay UE to the network node over the Uu DRB and/or downlink data for the relay UE is received by the relay UE from the network node over the Uu DRB.

6. The method of claim 4, wherein the SDAP header includes a field of a Quality of Service (QoS) flow identity.

7. A method for adaptation layer configuration, wherein an adaptation layer is above a Uu Radio Link Control (RLC) layer and below a Uu Packet Data Convergence Protocol (PDCP) layer, comprising:
a network node transmits a first Radio Resource Control (RRC) message including an adaptation layer configuration for a first Uu logical channel to a relay User Equipment (UE), wherein the adaptation layer configuration is used for the relay UE to establish an adaptation layer for the first Uu logical channel and the network node cannot reconfigure the relay UE to release the adaptation layer for the first Uu logical channel after the first Uu logical channel is established; and
the network node transmits a second RRC message including no adaptation layer configuration for a second Uu logical channel to the relay UE, wherein the network node cannot reconfigure the relay UE with an adaptation layer for the second Uu logical channel after the second Uu logical channel is established.

8. The method of claim 7, wherein an adaptation layer header is always present for the first Uu logical channel after the first Uu logical channel is established, and the adaptation layer header includes a field of a local UE identifier and/or a field of a radio bearer identity (ID).

9. The method of claim 7, wherein uplink data from a remote UE is forwarded by the relay UE to the network node over the Uu logical channel and/or downlink data from the network node is forwarded by the relay UE to the remote UE over the Uu logical channel.

10. The method of claim 7, further comprising:
the network node transmits a third RRC message to the relay UE to establish a Uu Data Radio Bearer (DRB), wherein the third RRC message includes a Service Data Adaptation Protocol (SDAP) layer configuration for the Uu DRB, and a field in the SDAP layer configuration indicates whether a SDAP header is present for the Uu DRB and a value of the field in the SDAP layer configuration cannot be changed after the Uu DRB is established.

11. The method of claim 10, wherein uplink data of the relay UE is transmitted by the relay UE to the network node over the Uu DRB and/or downlink data for the relay UE is received by the relay UE from the network node over the Uu DRB.

12. The method of claim 10, wherein the SDAP header includes a field of a Quality of Service (QoS) flow identity.

13. A network node for adaptation layer configuration, wherein an adaptation layer is above a Uu Radio Link Control (RLC) layer and below a Uu Packet Data Convergence Protocol (PDCP) layer, comprising:
a control circuit;
a processor installed in the control circuit; and
a memory installed in the control circuit and operatively coupled to the processor;
wherein the processor is configured to execute a program code stored in the memory to:
transmit a first Radio Resource Control (RRC) message including an adaptation layer configuration or an information for a Uu logical channel to a relay User Equipment (UE), wherein a field in the adaptation layer configuration indicates whether or not an adaptation layer header is present for the Uu logical channel and a value of the field cannot be changed after the Uu logical channel is established, and wherein the information indicates whether or not an adaptation layer is established for the Uu logical channel and the information cannot be changed after the Uu logical channel is established.

14. The network node of claim 13, wherein the adaptation layer header includes a field of a local UE identifier and/or a field of a radio bearer identity (ID).

15. The network node of claim 13, wherein uplink data from a remote User Equipment (UE) is forwarded by the relay UE to the network node over the Uu logical channel and/or downlink data from the network node is forwarded by the relay UE to the remote UE over the Uu logical channel.

16. The network node of claim 13, wherein the processor is configured to execute a program code stored in the memory to:
transmit a second RRC message to the relay UE to establish a Uu Data Radio Bearer (DRB), wherein the second RRC message includes a Service Data Adaptation Protocol (SDAP) layer configuration for the Uu DRB, and a field in the SDAP layer configuration indicates whether a SDAP header is present for the Uu DRB and a value of the field in the SDAP layer configuration cannot be changed after the Uu DRB is established.

17. The network node of claim 16, wherein uplink data of the relay UE is transmitted by the relay UE to the network node over the Uu DRB and/or downlink data for the relay UE is received by the relay UE from the network node over the Uu DRB.

18. The network node of claim 16, wherein the SDAP header includes a field of a Quality of Service (QoS) flow identity.
